(19) United States
(12) Patent Application Publication
(10) Pub. No.: US 2011/0120934 A1
(43) Pub. Date: May 26, 2011

(54) METHOD OF PRODUCING MULTIPLE CHANNELS FOR USE IN A DEVICE FOR EXCHANGE OF SOLUTES BETWEEN FLUID FLOWS

(75) Inventor: Johan Siverklev, Goteborg (SE)

(73) Assignee: Air to Air Sweden AB

(21) Appl. No.: 12/624,612

(22) Filed: Nov. 24, 2009

(51) Int. Cl. B01D 29/07; B23P 11/00

(52) U.S. Cl. 210/490; 29/428

(57) ABSTRACT

The present invention relates to a method of producing multiple channels for use in a device for exchange of solutes between at least two fluid flows. The invention further relates to such a device. At least a first and a second sheet are comprised. The method comprises the steps of providing at least one of the first and second sheets with at least one profiled surface and joining the first and second sheets together with the profiled surfaces facing against each other. Channels are formed by the shape of the profiled surfaces.

### FIELD OF INVENTION

The present invention relates generally to exchange of solutes between fluid flows, and more specifically to a method of producing multiple channels for use in a device for exchange of solutes between fluid flows. The invention further relates to a device for exchange of solutes between at least two fluid flows. The device comprises a first and a second sheet where at least one of the sheets is provided with a profiled surface. The sheets are joined together with the profiled surfaces facing against each other, whereby channels are formed between the two sheets by the shape of the profiled surfaces.

### BACKGROUND

Today there are many different applications where diffusion is used to enrich a fluid flow with solutes from another fluid flow, or to remove unwanted solutes or substances from the fluid flow. One example is in HVAC (Heating, Ventilation and Air Conditioning) where water vapour can be removed from a gas stream in order to reduce power consumption by reduced condensation in a cooler unit or to recycle energy from exhaust air in e.g. a building. Another example is reverse osmosis for desalinating water.

Different methods are used when it comes to separating water vapour from a fluid; such as rotating wheels with moisture capture or plate heat exchangers with semi permeable membranes. In gas drying technologies bundles of tubing, made of materials like Nafion™, are used.

However, these different methods of removing water vapour from fluids do have certain disadvantages; rotating exchangers are provided with moving parts which cause extra costs for maintenance. Further, rotating exchangers increases the risk of contamination between airstreams. Plate exchangers show low efficiency in regards to enthalpy and Nafion™ tubing is expensive.

Producers of these technologies all try to find the most cost efficient way of producing these effects, and therefore different methods are developed. In conventional plate-based heat- or moisture exchangers, the layers of the exchanger are often made up with spacers or distancing members or a support structure, onto which a membrane is laid. Such structures are common but fail to achieve high cost efficiencies due to their need for spacers, which can become expensive depending on the material used.

Further, the spacers also raise the total weight of the exchanger. Due to the weight, more supports are needed when mounted, and increased weight also increases risks due to handling during maintenance. Also the costs for transportation increase with heavy weight.

In some gas drying technologies a multitude of small tubes are used in order to provide a high moisture exchange surface area coupled with good flow characteristics through the bundles of tubing, while the gas flow characteristics on the outside of the bundle are largely neglected, often without adequate spacing for flow between the tubes.

Tubes in a bundle are usually used in conjunction with another fluid stream that goes in counter- or cross-current to the tubes, but on the outside, between the many tubes.

When using individually made tubes of very small diameter, production cost will become high since small tubes are technically complicated to manufacture and refine into a product, and, as a consequence, the final product will become expensive. Another drawback is when tubes are packed into a bundle; in current contemporary products, no satisfactory space allowance is provided for the flow characteristics in between the tubes.

### SUMMARY OF THE INVENTION

The present invention relates to a method of producing multiple channels for use in a device for exchange of solutes between at least two fluid flows overcoming the disadvantages and drawbacks mentioned above. A first and a second sheet are comprised in the device. The method comprises the steps of providing at least one of the first and second sheets with at least one profiled surface, and joining the first and second sheets together. Thereby, channels are formed by the shape of the profiled surface.

The present invention provides a method enabling production of multiple thin channels to a very low production cost. Further, the method provides for an alternative way of manufacturing multiple channels of infinite variation using favourable flow patterns.

According to another embodiment, the method comprises the further step of providing each of the first and second sheets with at least one profiled surface and joining the first and second sheets together with the profiled surfaces facing against each other, whereby channels are formed by the shape of the profiled surfaces.

According to another embodiment, wherein a plurality of sheets are comprised, the method comprises the further step of joining the plurality of sheets together, whereby channels in multiple layers are formed by the shape of the profiled surfaces.

According to another aspect of the present invention, a device for exchange of solutes between at least a first and a second fluid flow is provided. The device comprises at least a first and a second sheet wherein the first sheet being provided with at least one profiled surface. The first and second sheets are joined together whereby channels are formed by the shape of the profiled surface.

The device according to the present invention is particularly useful for exchanging a substance from a first fluid flow to a second fluid flow, in order to remove or separate the substance from the first fluid flow.

According to another embodiment, each of the first and second sheet provided are with profiled surfaces, and the first and second sheet are joined together with the profiled surfaces facing against each other.

According to another embodiment, the sheets are provided with profiled surfaces mirrored to each other.

According to another embodiment, the cross section of the channels varies along the length of the device.

According to another embodiment, the number of the channels along the length of the device varies.

According to another embodiment, comprises the device further a plurality of sheets stacked in multiple layers.

According to another embodiment, the sheet material has a high solubility to water.

According to another embodiment, the sheet material has a pore size between 0.1-50 nanometers.

According to another embodiment, the sheet material has a pore size of 50-500 nanometers.

According to another embodiment at least one of the sheets is hydrophobic.

According to another embodiment at least one of the sheets is hydrophilic.

According to yet another embodiment at least one of the sheets is a metal.

The high exchange surface area provided by a multitude of channels, coupled with good flow characteristics between layers provides an ideal situation for diffusion transfer between fluid streams.

The present design allows for any distance between layers according to needs. The flow characteristics between layers can also be adjusted by increasing the distance between layers or staggering the layer layout.

A further advantage is, for example in the case that a fluid is to be dried, that a larger stream of air may be flowing outside the channels, or between layers in the embodiments provided with more than one layer, whereby the fluid inside the channels is more effectively dried. By suitable design of the distance between layers, the amount of flow between layers may be optimised for the application.

The present invention provides a device allowing for a counter current design with a tight configuration and no need for separate spacer material to allow flow across the sheets. Further, the device provides exceptionally good flow characteristics between layers due to its design with multiple channels and stacked layer design with adjustable distance between layers. Also, the integrated channels provide low maintenance and low risk of tear since there is no wear due to vibrations of the sheets against support structures.

Yet a further advantage is that the device is cheap to manufacture with automatic separation of individual channels and with good and independently adjustable outside flow characteristics. Further, the present invention provides a device for solute exchange that eliminates the need for additional support structures between sheets while at the same time providing a means for counter current flow, which improves the efficiency significantly compared to conventional technology.

Further preferred embodiments are defined by the dependent claims.

### BRIEF DESCRIPTION OF DRAWINGS

The invention is now described, by way of example, with reference to the accompanying drawings, in which:

FIG. 1 shows a device for exchange of water vapour according to prior art.

FIG. 2 shows a sheet with a profiled surface according to one embodiment of the present invention.

FIG. 3 shows a sheet with a profiled surface according to another embodiment.

FIG. 4 shows two sheets with profiled surfaces joined together according to one embodiment of the present invention.

FIG. 5 shows a plurality of sheets with profiled surfaces joined together.

FIGS. 6 and 7 show sheets with alternative profiled surfaces.

FIG. 8 shows a plurality of sheets joined together in staggered layers.

FIG. 9 shows two sheets with profiled surfaces joined together according to yet another embodiment of the present invention.

FIG. 10 shows one sheet with profiled surfaces joined together with a sheet with a smooth surface according to one embodiment of the present invention.

FIG. 11 shows a sheet with yet another alternative profiled surface.

### DETAILED DESCRIPTION OF PREFERRED EMBODIMENTS

In the following a detailed description of a preferred embodiment of the present invention will be given.

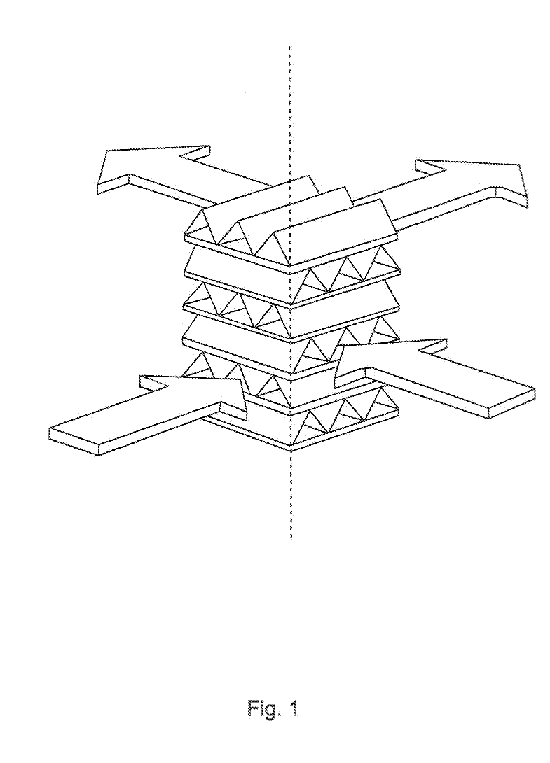

FIG. 1 shows a device for exchange of water vapour according to prior art. In conventional technology, a corrugated material or a flow distribution member is used between plain sheets of permeable material to define channels and flow direction and to provide a uniform spacer for separating layers. In some examples the sides of the sheets are turned down to provide spacers. This design is always limited to a cross flow configuration.

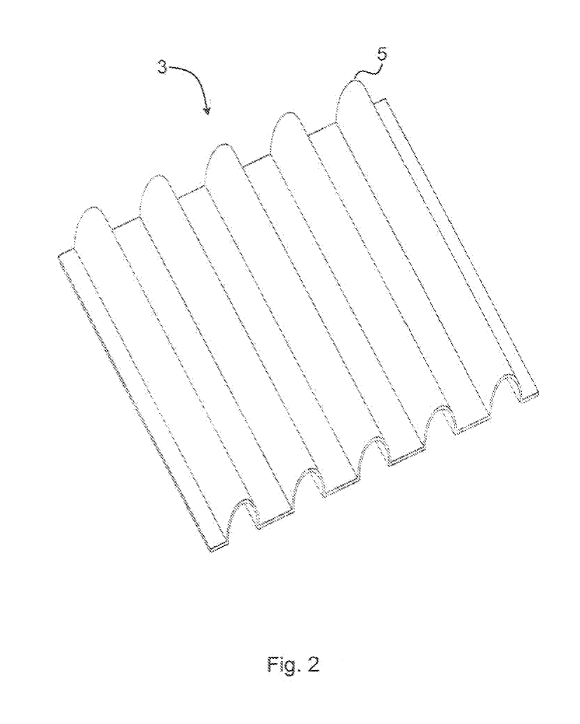

FIG. 2 shows a sheet 3 with a profiled surface 5 according to the present invention. To create the shape of the profiled surface 5 several different methods may be used in manufacturing. For example, the sheet can be a corrugated plate. As a further example, a sheet of a material can be heated to a degree where it is deformable and then cooled after shaping it over a mould/body and thereby letting the shape set. Once deformed permanently, the shape will stay. Another way is to let a lot of extremely thin threads fall randomly over a mould/body e.g. through electro spinning, to produce a shape that, once it sets, keeps its shape even when deformed. Yet another way to create the shape of the profiled surface 5 is to cut channels with favourable flow patterns into one side, or both sides, of a sheet of a solid or porous material. The material of the sheets 3, 4 may be semi permeable, or permeable to certain substances or solutes. The material of the sheets may be either porous or solid or both.

The methods described above are especially suitable when the dimension of the channels 1 is small. With those methods small channels with a cross section of only a few millimetres may be produced easily and cost efficiently.

The shape of the profiled surface, and thus the cross section of the channels formed by the surfaces, may vary, depending on desired flow characteristics. The cross section of the channels may for example be circular, hexagonal, square or triangular. A first and a second fluid may flow counter-current to each other, inside and outside of the channel 1 respectively.

The fluids in the channels may be a gas or a liquid.

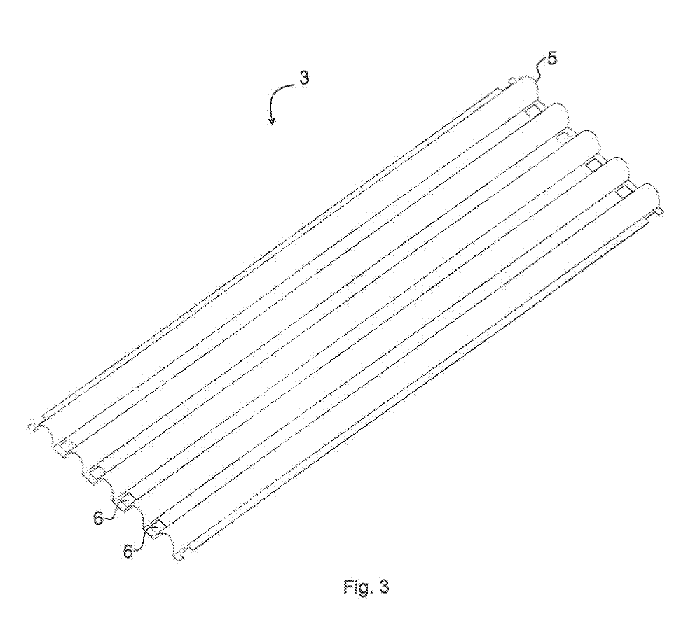

FIG. 3 shows another sheet 3 with a profiled surface 5 according to one embodiment of the invention. The sheets is further provided with openings to facilitate flow between layers 7 when a plurality of sheets are joined together in multiple layers 7.

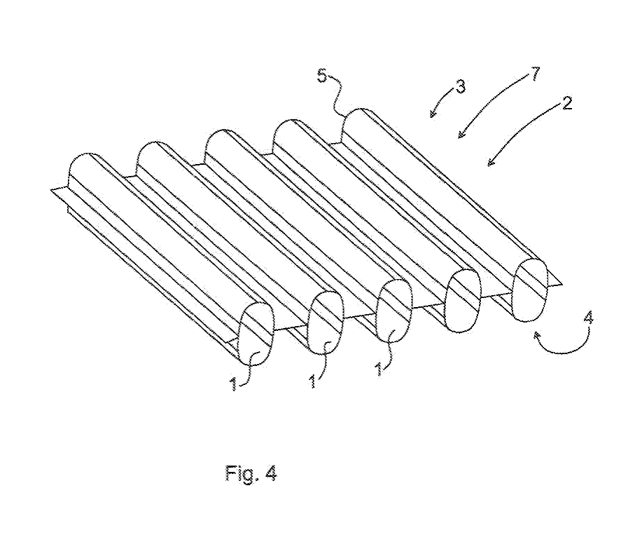

FIG. 4 show two sheets 3, 4 with profiled surfaces 5 joined together according to the present invention. By providing a sheet of a base material with a profiled surface 5, for example as shown in FIG. 1, and by joining two such sheets 3, 4 of opposite and preferably mirrored configured profiled surfaces 5 to each other, a multiple of small channels 1 can be formed by an easily automated process. Joining the sheets 3, 4 together may be achieved by for example welding, gluing or fusing, or any other suitable adhesive process that would join the two profiled plates hermetically together. The sheets 3, 4 are provided with a profiled surface 5 whereby channels 1 with circular cross-sections are achieved. The channels 1 may have any other suitable shape, for example oval, hexagon or square.

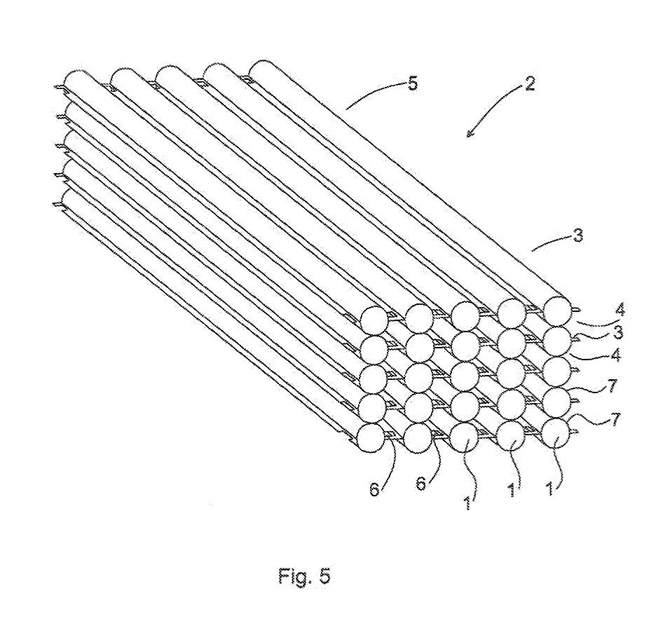

FIG. 5 shows a plurality of sheets 3, 4 joined together. When stacked, as shown in the figure, the sheets 3, 4 form multiple layers 7. Such a configuration results in a low pressure drop when fluids flow from one side to the other, thereby securing and maintaining the flow characteristics of the channels and an unobstructed fluid flow between the layers 7, outside the channels 1.

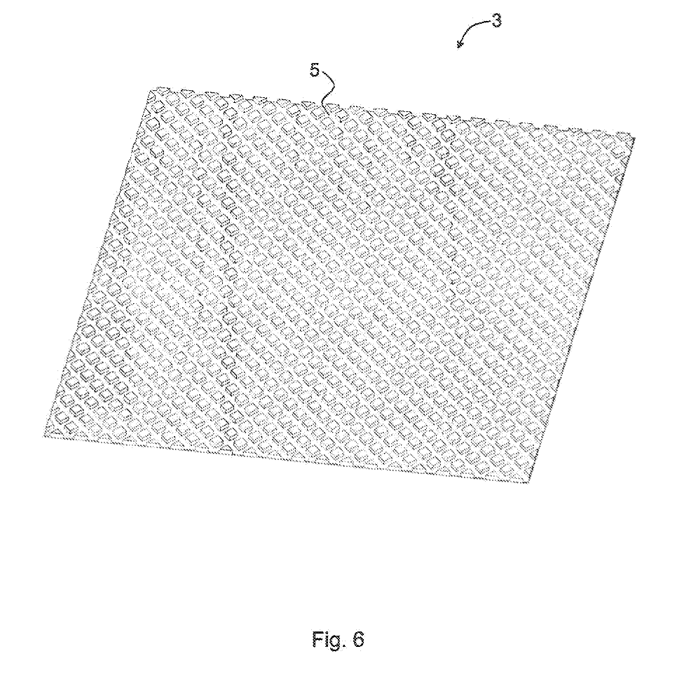

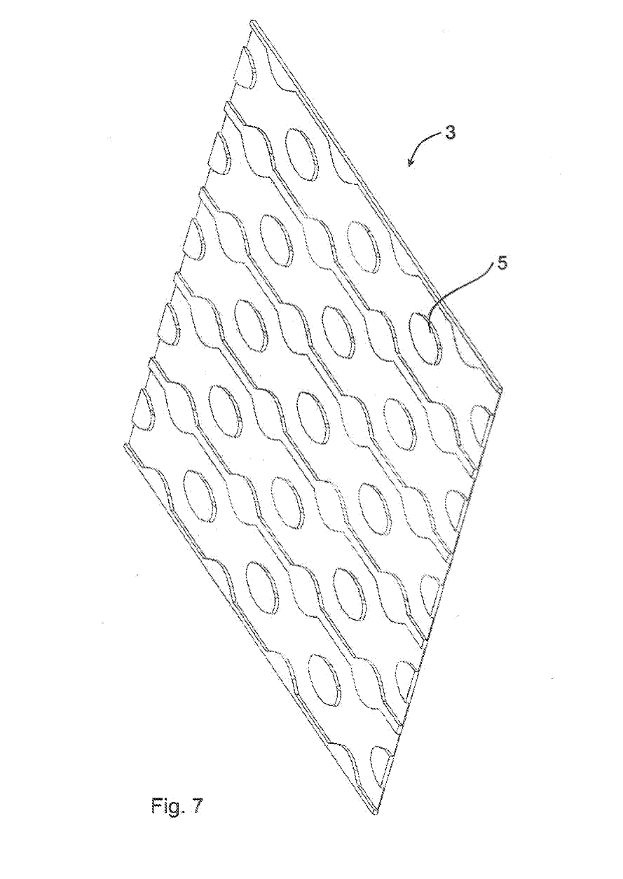

FIGS. 6 and 7 show sheets 3 with alternative profiled surfaces 5.

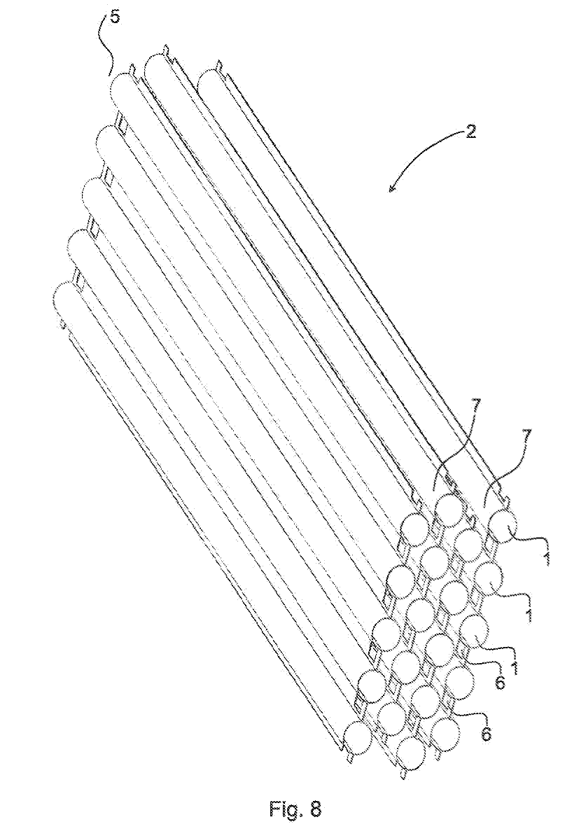

FIG. 8 shows a plurality of sheets 3, 4 joined together in multiple layers 7. The layers 7 are displaced in relation to each other whereby a device with plurality of layers 7 with a staggered configuration is provided. A staggered formation reduces distance between layers 7 and thus increases the total surface area per volume unit of the configuration, and the unit can thus be made more compact while maintaining the same surface area.

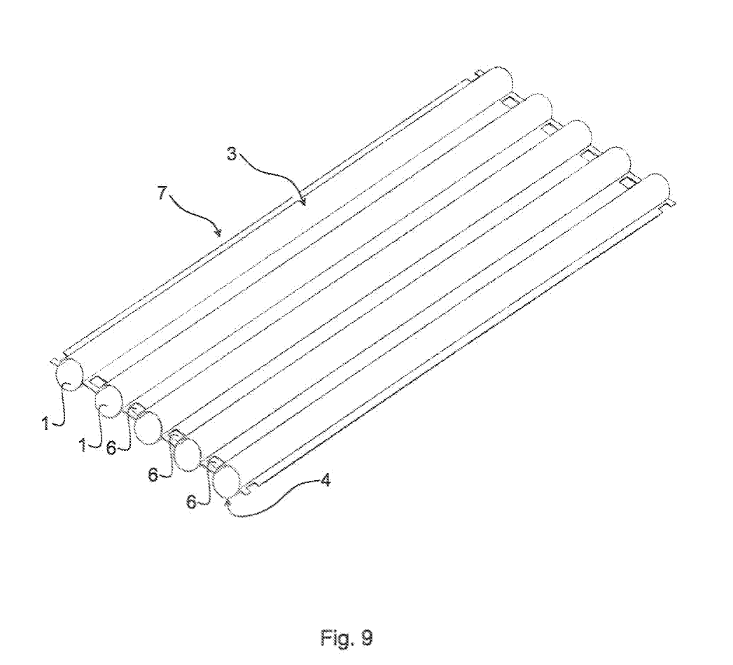

FIG. 9 shows two sheets with profiled surfaces joined together.

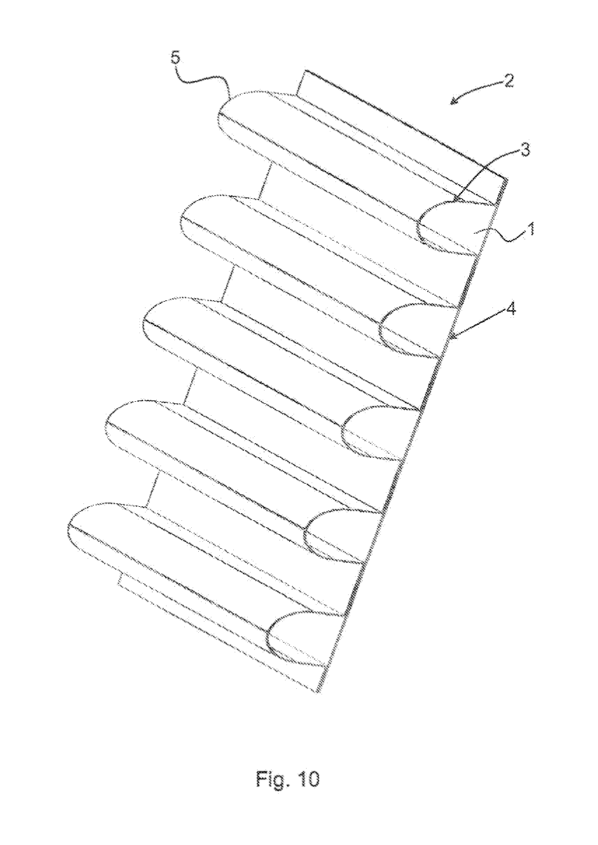

FIG. 10 shows one sheet 3 with profiled surfaces 5 joined together with a sheet with a smooth surface. Thereby, channels 1 showing a half-circular cross-section is provided.

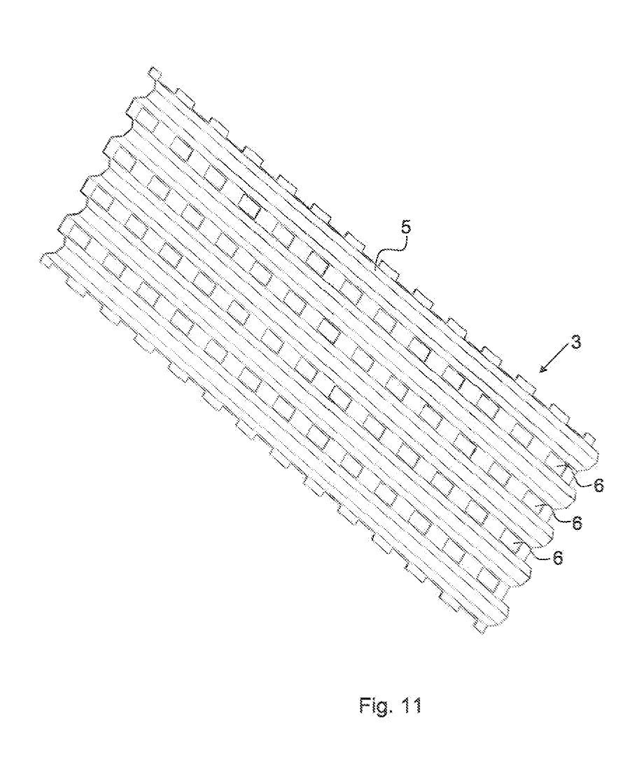

FIG. 11 shows a sheet with an alternative profiled surface 5. The sheet is also provided with a plurality of openings 6 to facilitate flow between layers 7 when a plurality of sheets 3, 4 are joined together in multiple layers 7.

In order to separate the entry of flows, openings can be cut between the channels. This provides entry channels perpendicular to the main direction of the channels, thereby separating the flow outside the channels, or, in the case of multiple layers, between layers, from the entry point of the flow inside the channels. If the configuration of multiple layers 7 is staggered, the same method may be used for a diagonal channel, perpendicular to the channels to feed the flow between layers 7.

The profiled surfaces 5 may be formed by any suitable method, for example by heating the sheets, deforming them whereby the surfaces are profiled, and then cooling them whereby the shape of the profiled surfaces stay in their deformed shape. Another example is letting a plurality of thin threads fall randomly over a body with a profiled surface, whereby a sheet with a profiled surface 5 is created that, once set, will keep its shape. Further alternative may be cutting channels into one side, or both sides, of a first and a second sheet of a solid or porous material. Yet further the profiled surface may be provided by applying a pattern of a plastic or other suitable material on sheets.

Further, openings 6 can be cut between the channels 1 in order to provide an inlet that distributes flow from a direction perpendicular to the channels 1, in between layers 7. This provides unobstructed flow perpendicular to the main direction of the channels, thereby separating the flow between the channels from the entry point of the flow inside the channels. If the configuration of layers 7 is staggered, the same method may be used for a diagonal channel, perpendicular to the channels to feed the flow between layers 7.

In order to distribute flows evenly and easily between layers 7, openings 6 can be cut either between the ends of the channels (primarily for flow distribution), or in intervals along the whole length of the channels, providing a simple means for pressure equalization and easy flow path.

In order to provide a bundle of channels for cross flow or counter current flow, uniformly spaced openings can be cut between channels to provide for an unobstructed flow between channels between channels from two directions (top to bottom or side to side), both perpendicular to the main direction of flow inside the channels.

The invention has mainly been described above with reference to a few embodiments. However, as is readily appreciated by a person skilled in the art, other embodiments than the ones disclosed above are equally possible within the scope of the invention, as defined by the appended patent claims.

1. A method of producing multiple channels for use in a device comprising at least a first and a second sheet for exchange of solutes between at least a first and a second fluid flow,
comprising the steps of:
providing at least one of said sheets with at least one profiled surface,
joining said first and second sheets together, whereby channels are formed by the shape of the profiled surface.

2. The method according to claim 1, comprising the further step of
providing each of said first and second sheets with at least one profiled surface,
joining said first and second sheets together with said profiled surfaces facing against each other, whereby channels are formed by the shape of the profiled surfaces.

3. The method according to claim 1, wherein a plurality of joined first and second sheets are stacked together, whereby channels in multiple layers are formed by the shape of the profiled surfaces.

4. A device for exchange of solutes between at least a first and a second fluid flow,
comprising:
at least a first and a second sheet, said first sheet being provided with at least one profiled surface,
said first and second sheets are joined together whereby channels are formed by the shape of the profiled surface.

5. The device according to claim 4, wherein each of said first and second sheets are provided with profiled surfaces, and wherein said first and second sheets are joined together with said profiled surfaces facing against each other.

6. The device according to claim 5, wherein said sheets with profiled surfaces are mirrored to each other.

7. The device according to claim 4, wherein the cross sections of said channels varies along the length of the device.

8. The device according to claim 4, wherein the number of said channels varies along the length of the device.

9. The device according to claim 4, further comprising a plurality of sheets stacked in multiple layers.

10. The device according to claim 4, wherein the sheet material has a high solubility to water.

11. The device according to claim 4, wherein the sheet material has a pore size between 0.1-50 nanometers.

12. The device according to claim 4, wherein the sheet material has a pore size of 50-500 nanometers.

13. The device according to claim 4, wherein at least one of said sheets is hydrophobic.

14. The device according to claim 4, wherein at least one of said sheets is hydrophilic.

15. The device according to claim 4, wherein at least one of said sheets is a metal.
